(19) United States
(12) Patent Application Publication
(10) Pub. No.: US 2005/0131598 A1
(43) Pub. Date: Jun. 16, 2005

(54) Machine sensor with redundant datalogger OEM datalogger

(76) Inventor: R. Glenn Akhavein, Bradenton, FL (US)

Correspondence Address: R. Glenn Akhavein, 5112 Coral Blvd., Bradenton, FL, 34210, US

(21) Appl. No.: 10/978,977

(22) Filed: Oct. 30, 2004

Related U.S. Application Data
(60) Provisional application No. 60/517,226, filed on Oct. 31, 2003.

(51) Int. Cl. G06F 19/00

(52) U.S. Cl. 701/29; 701/35

(57) ABSTRACT

In a complex machine such as a vehicle, the apparatus and control system notifies the machine or vehicle electronic control unit, if present, as well as maintaining a post event timer or counter that is specifically designed to help the component or subsidiary system OEM determine fault detection, failure diagnosis, and time dependant post event actions that are or are not taken by the operator of the machine or vehicle. The information that is kept by the onboard OEM datalogger is designed for their use first, as well as for the vehicle manufacturer.

### BACKGROUND OF INVENTION

This invention pertains to a machine sensing system that is designed to have an onboard datalogging and post-event time keeping ability. This invention is applicable for a variety of machines; however, for the sake of clarity and simplicity, a vehicle will be used as the example machine. More and more mechanical systems are being controlled by electronic systems. The proliferation of sensors and electronic control systems allow vehicles to monitor and adjust their operation without the intervention of an operator. Most of the electronic systems aboard a modern vehicle have the ability to sense specific parameters, and make adjustments according to predefined algorithms and/or learned algorithms.

Along with making adjustments to optimize the operation of the vehicle, these electronic control systems are also designed to detect minor or major faults within the vehicle. One method of classifying faults in a vehicle is to view them as either internal to the electronic control system or external to the electronic control system. The internal faults are generally detected by self-diagnostic systems that run predefined tests to determine if the electronic control system is working correctly. Component and/or subsidiary system sensors generally detect the external faults. Once detected, the fault information is sent to the system controller for processing; a system controller will be referred to as an Electronic Control Unit, (ECU).

The ECU is designed to control the vehicle by making decisions based upon feedback from components and sub-systems, monitor vehicle operational conditions and internal and external faults, record operational information and fault conditions, communicate both operational information, and fault information to operators and interface with diagnostic equipment.

Today, most vehicles, and other complex machines, are made up of a variety of components and subsidiary systems from different suppliers. These suppliers or Original Equipment Manufacturers, (OEM's), supply the components and/or subsidiary systems that are then combined to make the vehicle or complex machine. Sometimes the subsidiary systems have a subsidiary electronic control unit, (SECU). These SECU's control the subsidiary system and also communicate with the ECU so that the entire vehicle operates correctly. One limitation of this system, from the viewpoint of the OEM, is that even though the information is detected by the OEM's SECU, the recording and communicating of fault conditions is usually handled by the ECU, which is out of their control. This invention relates to the use of a post fault event datalogging system that interfaces with the vehicle's ECU as well as maintains its own recording and communicating functionality.

### BRIEF SUMMARY OF THE INVENTION

In a complex machine such as a vehicle, the apparatus and control system notifies the machine or vehicle electronic control unit, if present, as well as maintaining a post event timer or counter that is specifically designed to help the component or subsidiary system OEM determine fault detection, failure diagnosis, and time dependant post event actions that are or are not taken by the operator of the machine or vehicle. The information that is kept by the onboard OEM datalogger is designed for their use first, as well as for the vehicle manufacturer.

When subsidiary systems fail, it is not always easy to ascertain what component was the initial trigger for a failed system. For example;
A large bus develops a transmission fluid leak because the OEM that supplied a fitting manufactured it incorrectly, and this causes the transmission fluid to overheat and crack a tube in the transmission heat exchanger. The cracked tube causes antifreeze to get into the transmission, which immediately begins to breakdown portions of the transmission, which in turn leads to a catastrophic transmission failure. When this transmission is examined, the cause of the transmission failure will most probably be linked to the cracked heat exchanger; therefore, the heat exchanger OEM will be liable for warranty damages even though it was not their component that was the initial cause of the failure.

If the heat exchanger OEM had this invention as part of their design, they would not be liable for the damages. If the heat exchanger had a dielectric sensor built into it that was tied into the vehicles ECU through the OEM's SECU, the aforementioned situation could have been recorded by both the ECU and the onboard redundant datalogger.

The heat exchanger sensor would have been monitoring the dielectric constant and temperature of the fluid inside of the exchanger. Air has a dielectric constant of 1, oil between 2 and 4, glycol is 37, and water about 80. Normally the dielectric constant of the transmission oil will slowly increase from 2 to 4 as the temperature increases, (this is dependent upon type of oil and additives). Under normal operating conditions, the heat exchanger SECU would see the small increase in the dielectric constant with an accompanying increase in the temperature during the time that the fluid warmed up, and then both the dielectric constant and temperature would remain constant during operation. In the event of an antifreeze leak, one that was caused by a faulty heat exchanger, the heat exchanger SECU would see would see a sudden abnormally high increase in the dielectric constant inside the exchanger while seeing no significant increase, and possibly even a decrease in temperature. Just a fraction of a percentage of water would cause the dielectric constant to increase past the level of usable hot oil.

In the scenario where the transmission fluid level dropped due to a leak elsewhere in the vehicle, which then caused the heat exchanger to crack due to overheated oil, the heat exchanger SECU would see the same small increase in the dielectric constant with an accompanying increase in the temperature during the time that the fluid warmed up. As transmission fluid leaked out of the system the heat exchanger SECU would see an abnormal increase in temperature and an abnormal increase in the dielectric constant due to the oil breaking down as a result of overheating. Once the transmission fluid overheated to the point where it caused the heat exchanger to crack, the SECU would see a sudden increase in the dielectric constant due to the mixing of antifreeze in the transmission fluid. The information provided to the heat exchanger SECU from the dielectric and temperature sensors would provide the heat exchanger OEM with the post event data needed to show that their product was damaged by another faulty system and not the root cause of the transmission failure.

As shown in the previous example, this invention provides an OEM with the ability to keep additional information pertinent to their individual component or sub-system as well as providing the ECU, vehicle manufacturer, with the necessary information about the state of the OEM component or sub-system.

The current invention can also be used by the vehicle manufacturer to reduce warranty claims due to improper use of their vehicle. This invention is designed to keep a redundant datalogger with a post event counter. Using the aforementioned example, the vehicle manufacturer can state that if their vehicle detects an antifreeze leak, the operator will be notified and then has a set amount of time to shut down the vehicle. Since the system is designed keep up with post event datalogging, the vehicle manufacturer can use this information to determine if the operator heeded the warnings and shut down the vehicle in the proper amount of time so as not to void the warranty.

### BRIEF DESCRIPTION OF THE DRAWINGS

FIG. 1 is view of the main parts of the OEM sub-system electronic control system, OEM SECU.

FIG. 2 is a view of how the OEM SECU interfaces with the machine.

### DESCRIPTION ON AN EMBODIEMENT OF THE INVENTION

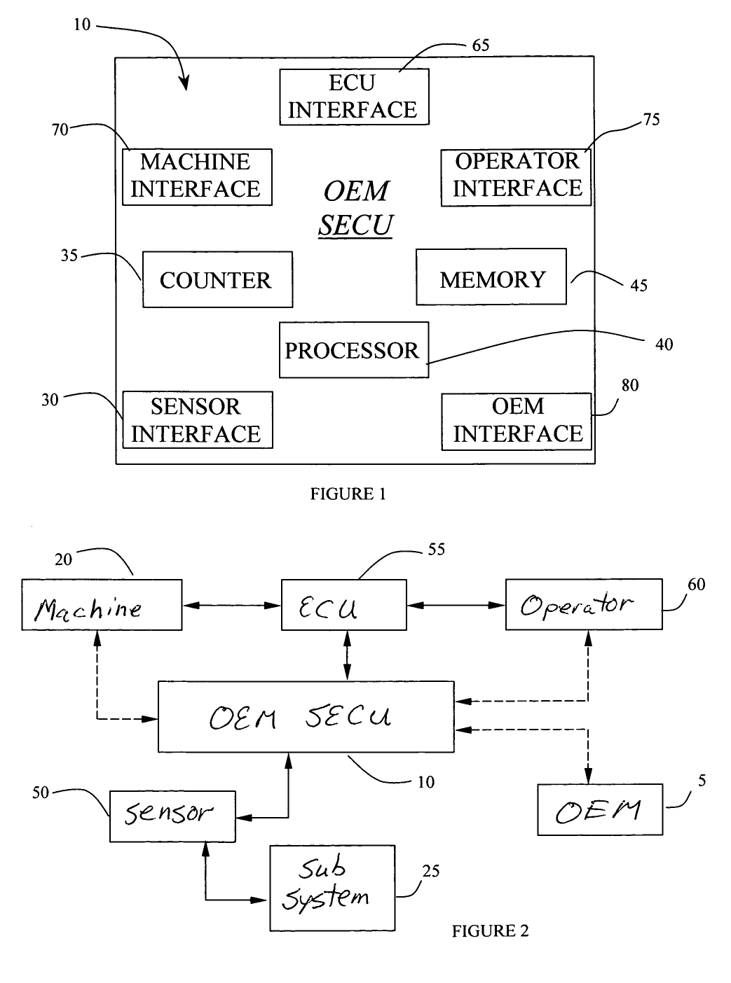

Referring to FIG. 1 and FIG. 2, an OEM 5, which supplies a sub-system 25 to a machine 20 can use a sub-system control unit, OEM SECU, which is shown and generally designated as 10. The OEM SECU 10 can be placed anywhere on the machine 20 depending upon machine 20 design. The OEM SECU 10 is comprised of at least one sensing means, sensor 50 that is responsible for sensing at least one parameter of a machine component or sub-system, sub-system 25 and relaying that information to the OEM SECU 10 via the sensor interface 30. The OEM SECU 10 also has counting means, counter 35, which is used to keep up with post event time and/or time of use data. The OEM SECU 10 also has a processing means, processor 40, which is used to control the functions of the OEM SECU 10. The post event information that is sensed from the sensor interface 30 and the counter 35 is stored on the OEM SECU 10 in the memory means, memory 45.

During normal operation of the machine 20, the machine's electronic control unit, ECU 55, is responsible for controlling the functions of machine 20. The ECU 55 receives information from the OEM SECU 10, via the ECU interface 65, and processes it in whatever manner it was designed for. However, when there is a fault with a sub-system 25 that the OEM SECU 10 is responsible for, the OEM SECU 10 begins maintaining time and/or time of use information via the counter 35 and stores that in the memory 45. The OEM SECU 10 also sends this fault information to the ECU 55 so that it may use the information to continue to control the machine 20 and, if so designed, notify the machine operator 60. In some cases the OEM SECU 10 may also send information directly to the machine 20, via the machine interface 70. Depending upon the design of the machine 20, the OEM SECU 10 may also directly notify the machine operator 60, via the operator interface 75.

Once the OEM SECU 10 has detected a fault it counts time and/or time of use via the counter 35. This post event time and/or time of use information is maintained by the OEM SECU 10 and is stored in the OEM SECU 10's memory 45. When the faulty sub-system 25 that the OEM SECU 10 has been responsible for controlling is analyzed, the OEM 5 connects to the OEM SECU 10 via the OEM interface 80 and retrieves the counter 35 information that has been stored in memory 45. This information can be used by the OEM 5 to determine if their component was the cause of the machine 20 fault or some other portion of the machine 20 caused the sub-system 25 to fail. This counter 35 information can also be used to verify if the machine operator 60 acted appropriately and in the correct amount of time as mandated by the machine 20 warranty.

Patents Cited

| | | | | | |
|---|---|---|---|---|---|
| 1. | 4,817,418 | 10.1987 | Asami et al. | 73/118.1 | Failure Diagnosis System for |
| | | | | | Vehicle |
| 2. | 4,939,652 | March 1988 | Steiner | 701/35 | Trip Recorder |
| 3. | 5,388,045 | August 1993 | Kamiya et al. | 701/35 | Self-Diagnostic Apparatus of |
| | | | | | Vehicles |
| 4. | 5,430,432 | July 1994 | Camhi et al. | 340/438 | Automotive Warning and |
| | | | | | Recording System |
| 5. | 5,594,646 | December 1994 | Yasunobu et al. | 701/35 | Method and Apparatus for Self- |
| | | | | | Diagnosis for an Electronic |
| | | | | | Control System for Vehicles |
| 6. | 5,599,460 | August 1993 | Schoiack et al. | 210/746 | Water/Glycol Sensor for Use in |
| | | | | | Oil Systems |
| 7. | 5,638,273 | March 1995 | Coiner et al. | 701/35 | Vehicle Data Storage and |
| | | | | | Analysis System and Methods |
| 8. | 6,590,402 | October 2001 | Wang et al. | 324/698 | Engine oil Contamination |
| | | | | | Sensor |
| 9. | 6,601,015 | January 1999 | Milvert et al. | 702/182 | Embedded Datalogger for an |
| | | | | | Engine Control System |

1. A method for a machine control system comprising:
sub-system made up of one or more sub-components and/or sub-systems;
sensing means for sensing at least one parameter of said sub-system;
evaluating means for processing one or more sensed parameters from said sensing means;
notifying means for providing said sensed, evaluated and counted information to another control system and/or operator;
counting means for evaluating the count of said sub-system;
data storing means for maintaining said information.

2. A method as set forth in claim 1, wherein said sensing means monitors one or more parameters of said sub-system that are of importance to either the sub-system or the main control system.

3. A method as set forth in claim 1, wherein said evaluating means is able to determine a fault event from the sensed parameters of said sub-system.

4. A method as set forth in claim 1, wherein said notifying means;
establishing a post event signal to the sub-system control system;
establishing a post event signal to the main control system;
establishing a post event signal to the operator;

5. A method as set forth in claim 4, wherein said post event signal sub-system control system, and/or main control system, and/or operator comprising:
signaling means that may be directly and/or indirectly connected via a contacting means;
signaling means that may be directly and/or indirectly connected via a non-contacting means.

6. A method as set forth in claim 1, wherein said counting means;
may be controlled by the main control system;
may be controlled by the sub-system;

7. A method as set forth in claim 1, wherein said counting means;
may be a real time clock;
may be an incremental value that translates into real time;
may be the real time duration of a particular combination of machine events;
may be an incremental value of the number of times a particular combination of machine events;
may be a plurality of counters that count according to different parameters;
may be continuous in its counting, stop counting when specified machine component events stop, or additive, that is start and stop each time specified machine component events start and stop.

8. A method as set forth in claim 7, wherein said counting means;
may send the same information to the main control system, and/or operator as it maintains itself;
may send different information to the main control system, and/or operator as it maintains itself;

9. A method as set forth in claim 8, wherein said information;
may be made accessible;
may be encrypted;

10. A method as set forth in claim 1, wherein said data storing means;
may be nonvolatile;
may be reset by the sub-control system, and/or main control system, and/or the operator, and/or the OEM may be reset only by the OEM;

11. An apparatus for a machine control system comprising:
sub-system made up of one or more sub-components and/or sub-systems;
sensing means for sensing at least one parameter of said sub-system;
evaluating means for processing one or more sensed parameters from said sensing means;
notifying means for providing said sensed, evaluated and counted information to another control system and/or operator;
counting means for evaluating the count of said sub-system;
data storing means for maintaining said information.

12. An apparatus as set forth in claim 11, wherein said sensing means monitors one or more parameters of said sub-system that are of importance to either the sub-system or the main control system.

13. An apparatus as set forth in claim 11, wherein said evaluating means is able to determine a fault event from the sensed parameters of said sub-system.

14. An apparatus as set forth in claim 11, wherein said notifying means;
establishing a post event signal to the sub-system control system;
establishing a post event signal to the main control system;
establishing a post event signal to the operator;

15. An apparatus as set forth in claim 14, wherein said post event signal sub-system control system, and/or main control system, and/or operator comprising:
signaling means that may be directly and/or indirectly connected via a contacting means;
signaling means that may be directly and/or indirectly connected via a non-contacting means.

16. An apparatus as set forth in claim 11, wherein said counting means;
may be controlled by the main control system;
may be controlled by the sub-system;

17. An apparatus as set forth in claim 11, wherein said counting means;
may be a real time clock;
may be an incremental value that translates into real time;
may be the real time duration of a particular combination of machine events;
may be an incremental value of the number of times a particular combination of machine events;
may be a plurality of counters that count according to different parameters;
may be continuous in its counting, stop counting when specified machine component events stop, or additive, that is start and stop each time specified machine component events start and stop.

18. An apparatus as set forth in claim 17, wherein said counting means;
may send the same information to the main control system, and/or operator as it maintains itself;
may send different information to the main control system, and/or operator as it maintains itself;

19. An apparatus as set forth in claim 18, wherein said information;
may be made accessible;
may be encrypted;

20. An apparatus as set forth in claim 11, wherein said data storing means;
may be nonvolatile;
may be reset by the sub-control system, and/or main control system, and/or the operator, and/or the OEM may be reset only by the OEM;

21. An apparatus for a machine detecting system for detecting the presence of water/glycol in lubricating oil comprising:
sub-system made up of one or more sub-components and/or sub-systems;
sensing means for sensing at least one parameter of said sub-system;
evaluating means for processing one or more sensed parameters from said sensing means;
notifying means for providing said sensed, evaluated and counted information to another control system and/or operator;
counting means for evaluating the count of said sub-system;
data storing means for maintaining said information.

22. An apparatus as set forth in claim 21, wherein said sensing means monitors one or more parameters of said sub-system that are of importance to either the sub-system or the main control system.

23. An apparatus as set forth in claim 21, wherein said evaluating means is able to determine a fault event from the sensed parameters of said sub-system.

24. An apparatus as set forth in claim 21, wherein said notifying means;
establishing a post event signal to the sub-system control system;
establishing a post event signal to the main control system;
establishing a post event signal to the operator;

25. An apparatus as set forth in claim 24, wherein said post event signal sub-system control system, and/or main control system, and/or operator comprising:
signaling means that may be directly and/or indirectly connected via a contacting means;
signaling means that may be directly and/or indirectly connected via a non-contacting means.

26. An apparatus as set forth in claim 21, wherein said counting means;
may be controlled by the main control system;
may be controlled by the sub-system;

27. An apparatus as set forth in claim 21, wherein said counting means;
may be a real time clock;
may be an incremental value that translates into real time;
may be the real time duration of a particular combination of machine events;
may be an incremental value of the number of times a particular combination of machine events;
may be a plurality of counters that count according to different parameters;
may be continuous in its counting, stop counting when specified machine component events stop, or additive, that is start and stop each time specified machine component events start and stop.

28. An apparatus as set forth in claim 27, wherein said counting means;
may send the same information to the main control system, and/or operator as it maintains itself;
may send different information to the main control system, and/or operator as it maintains itself;

29. An apparatus as set forth in claim 28, wherein said information;
may be made accessible;
may be encrypted;

30. An apparatus as set forth in claim 21, wherein said data storing means;
may be nonvolatile;
may be reset by the sub-control system, and/or main control system, and/or the operator, and/or the OEM may be reset only by the OEM;
